(19) United States
(12) Patent Application Publication
(10) Pub. No.: US 2026/0299291 A1
(43) Pub. Date: Oct. 1, 2026

(54) Compact Privacy Display in an Instrument Panel of a Vehicle, Having a Free-Form Prism as Cover Pane

(71) Applicant: Bayerische Motoren Werke Aktiengesellschaft, Muenchen (DE)

(72) Inventor: Sebastian Takeshi LAMPEN, Tokyo (JP)

(21) Appl. No.: 19/478,441

(22) PCT Filed: Jun. 25, 2024
(86) PCT No.: PCT/DE2024/100563

§ 371 Date: Oct. 24, 2025

(30) Foreign Application Priority Data
Jul. 11, 2023 (DE) 10 2023 118 324.9

(51) Int. Cl. G02B 27/01; B60K 35/22

(52) U.S. Cl. CPC G02B 27/0101; B60K 35/22; B60K 2360/164; G02B 2027/0118

(57) ABSTRACT

A privacy display includes an imager configured to generate a light beam including display content and a cover pane that is transparent to the light beam and is intended for arrangement in a surface section of the instrument panel that faces an occupant on a front vehicle seat. The privacy display also includes a projection and/or imaging optical unit that is arranged between the imager and the cover pane in the beam path and is configured to display the display content as a real or virtual image that hovers in the air in front of or behind the cover pane. The cover pane is configured to deflect the light beam upwards in a prism shape to vertically reduce an installation space required for the privacy display and to output the light beam directly in the direction of a region of space intended for the eyes of the occupant.

### BACKGROUND AND SUMMARY

The invention relates to a privacy display for installation in an instrument panel of a vehicle for generating a real image or a virtual image floating freely in the air for a vehicle occupant. The invention is also directed to a vehicle equipped therewith.

So-called head-up displays (HUDs) are known for vehicles, which are used to show an image in the field of view of an occupant via reflection on a partially transparent reflection pane, typically a windshield or a combiner pane separately provided for this purpose. In this way, for example, speed information and other useful navigation, warning, and vehicle operation notifications can be overlaid in the form of a virtual image on the real surroundings in front of the vehicle, which are observed by the driver or another occupant. For this purpose, for example, an HUD for the driver in classic design comprises a projection unit housed in the instrument panel, which generates a light beam bundle having desired display content and projects it in suitable shape and direction onto the windshield of the vehicle or onto a combiner pane arranged in front of it in the vehicle interior, from which it is reflected to the eyes of the driver or to a spatial area (eyebox) predetermined for them.

In order to read the display of a head-up display, the driver therefore does not have to look away from the road and also does not have to refocus strongly with a suitable design of the projection optical unit.

However, it is not easy to display the HUD image in the transparent area of the windshield with sufficient brightness and high enough contrast even in high ambient brightness.

Head-up displays are also proposed in the prior art as front passenger entertainment or as driver entertainment during parking or autonomous driving. In addition to virtual image display, for example, the generation of a real image floating in the air for one or more observers by way of an imaging concave mirror is known in this case from CN 217821128 U, wherein the beam path leads via reflection on the windshield to the eyeboxes of a driver and a front passenger during the use in the vehicle.

It is the object of the present invention to specify an alternative and/or improved display device for a vehicle, which enables an improvement in relation to known devices, for example with regard to the installation space, the contrast, the visibility, the image quality, and/or other aspects.

This object is achieved by a privacy display and by a vehicle equipped therewith according to the claimed invention. All refining features and effects mentioned for the privacy display in the claims and the following description also apply in relation to the vehicle, and vice versa.

According to a first aspect, a compact privacy display is provided, which is designed for installation in an instrument panel of a vehicle. The vehicle can be a motor vehicle, but also any other land vehicle, aircraft, or water vehicle.

The privacy display comprises an image generator designed for generating a light beam bundle having desired display content (also called projector light herein) and a cover pane designed to transmit the light beam bundle. In principle, any imaging technology is suitable for the image generator, in particular a light-transmitting or light-emitting flatscreen display, a projector-based image generator, or a waveguide-based display. The cover pane is designed to be arranged in a surface section of the instrument panel which faces toward a vehicle occupant on a front vehicle seat, so that the cover pane is arranged with its surface directly opposite to the occupant in the installed state. Furthermore, the privacy display comprises a projection and/or imaging optical unit arranged in the beam path between the image generator and the cover pane, which is designed to display the display content as a real image floating freely in the air in front of the cover pane (i.e. in the passenger compartment) from the viewpoint of the occupant or as a virtual image floating beyond the cover pane (i.e. in the interior of the instrument panel or still further away).

In this case, the cover pane is designed as prismatic such that it deflects the light beam bundle upward so that an installation space required overall for the privacy display is thus vertically compressed and the light beam bundle leaves the cover plane in an emission direction here that leads directly (i.e. without further deflection surfaces) to a spatial area (eyebox) predetermined for the eyes of the mentioned occupant. The mentioned occupant can therefore see the generated image when he or she looks in the direction of the cover pane.

An eyebox is understood as usual as a spatial area from which the displayed real or virtual image is unrestrictedly visible. In other words, the light beam bundle is essentially restricted to this spatial area. Therefore, the generated image is only visible for that occupant whose eyes are located in the eyebox predetermined for this purpose, which does not go beyond the width of his or her vehicle seat, for example. On the one hand, confidential content (“privacy”) can be displayed to this occupant. On the other hand, other occupants, such as the driver, are not visually disturbed by this display, because they cannot see it.

One concept of the present invention is to implement a (free-form) prism as a cover pane in the instrument panel for installation space optimization and optics improvement in the integration of the projector (privacy display) described herein in the instrument panel. Otherwise, an installation space problem can occur in the integration of such a projector into the instrument panel, since the eyebox position and therefore also the required emission direction are predetermined by the vehicle geometry, while the available installation space in the instrument panel and its shape are likewise predetermined or very restricted. To resolve this installation space conflict and at the same time obtain more freedom in the design of the imaging and projection optical unit, in the privacy display presented herein, the cover glass is designed as a prism, in particular a free-form prism, which can follow the predetermined shape of the instrument panel and at the same time ensure a deflection of the light beam bundle. The installation space required for the image generator and the imaging and projection optical unit can accordingly be deflected or compressed and thus adapted to the predetermined installation space geometry in the instrument panel.

Moreover, the privacy display presented herein has the advantage over a head-up display in which the image is overlaid on bright exterior surroundings of the vehicle that here the cover pane having the interior of the instrument panel and the privacy display located behind it is used as the image background. The image brightness can thus be increased substantially independently of the ambient brightness and the contrast can also be significantly improved.

According to one embodiment, the prismatic cover pane is designed as a free-form prism having a free-form surface facing toward the occupant and/or the projection and/or imaging optical unit, which is designed for adaptation to a predetermined surface geometry of the instrument panel and/or for an additional image-correcting and/or imaging effect. Alternatively or additionally, the prism can have an at least approximately triangular shape in a vertical longitudinal section (which is taken in the beam propagation direction), which can taper downward, for example, in order to achieve the mentioned deflection upward.

In one specific design, the cover pane can comprise a particle admixture, coloration, tinting, and/or a polarization filter and can thus be darkened to such an extent that looking directly into the interior of the privacy display through the cover pane is substantially prevented for vehicle occupants and at the same time a contrast medium results for displaying the real or virtual image with a desired contrast. Since in the present case the cover pane having the interior of the instrument panel and the privacy display located behind it is used as the image background, the image contrast can be increased by its darkening. And since the image is not displayed against bright exterior surroundings of the vehicle, in contrast to the head-up display mentioned at the outset, a significantly better contrast result can already be achieved using a significantly lower intensity of the projector light than in an HUD, so that in spite of a certain attenuation of the projector light by the darkened cover pane, a higher contrast is achievable.

Since the ambient light has to pass the cover pane twice in contrast to the projector light in order to illuminate the interior of the privacy display for the occupants, it can also be attenuated at least twice as strongly as the projector light by light-absorbing particles or a suitable polarization filter in the cover pane.

The polarization filter can be designed here in particular as a circular polarizer, which is composed of a quarter-wave retarder facing toward the projection and/or imaging optical unit and a linear polarizer facing toward the occupant. The unpolarized ambient light incident from the outside on the cover pane is thus initially attenuated by half by the linear polarizer and then circularly polarized in the correspondingly aligned quarter-wave retarder. If this ambient light is reflected back in the interior of the privacy display toward the cover pane, it thus again has a linear polarization after the second passage through the quarter-wave retarder, but with a polarization direction rotated by 90° in relation to the transmission direction of the linear polarizer. The reflected ambient light is therefore blocked or absorbed by the linear polarizer, in other words completely extinguished.

Ideally, the image generator is designed in this design to generate the light beam bundle with a circular polarization such that after passage through the quarter-wave retarder it has a linear polarization transmitted by the linear polarizer and therefore can pass the polarization filter substantially unattenuated. Alternatively thereto, however, the projector light can also have a polarization, for example, which is not manipulated by the quarter-wave retarder. In this case, the projector light is linearly polarized parallel to the fast or slow axis of the quarter-wave retarder and is thus also transmitted by 50% by the linear polarizer.

Alternatively, however, any other polarization filter can also be used, such as a linear polarizer which transmits polarized projector light unattenuated in its transmission direction, but blocks at least half of the unpolarized ambient light.

According to one embodiment, the projection and/or imaging optical unit comprises at least one concave mirror, which can be designed, for example, for a beam-deflecting, image-enlarging, and/or image-correcting effect. Alternatively or additionally, the projection and/or imaging optical unit can also comprise, for example, planar mirrors and other deflection elements for folding the beam path and/or lenses and other imaging elements for generating the real image or for defining the display properties of the virtual image.

In particular, the projection and/or imaging optical unit can in this case comprise two concave mirrors located directly opposite to one another in the beam path of the light beam bundle. This can be expedient for a particularly compact beam path and/or for particularly good imaging properties, above all for generating the real image.

According to a further aspect, the above vehicle is provided. The spatial orientation terms used herein such as “above”, “below”, “lateral”, “horizontal”, “vertical”, etc. relate to the typical vehicle-fixed Cartesian coordinate system having longitudinal, transverse, and vertical axes of the vehicle perpendicular to one another.

The vehicle comprises a windshield, an instrument panel extending thereunder, and at least one front vehicle seat arranged opposite to the instrument panel. It is equipped with at least one privacy display of the type presented herein. Each of these privacy displays is integrated into the instrument panel here such that its cover pane forms a surface section of the instrument panel which faces toward a vehicle occupant on one of the front vehicle seats.

According to one embodiment, the cover pane is arranged in the instrument panel so that its user-side surface is flush with adjoining surface sections of the instrument panel. In other words, in this embodiment, the user-side surface of the cover pane follows the surface shape of the instrument panel or forms its continuation.

In particular, one of the privacy displays can be arranged opposite to a front passenger seat and can be designed for use as front passenger entertainment. Alternatively or additionally, one of the privacy displays can be arranged opposite to the driver seat and can be designed for use as driver entertainment during autonomous driving or in the parked vehicle.

The above aspects of the invention and the embodiments and specific designs thereof are explained in more detail hereinafter on the basis of an example illustrated in the appended drawings. The drawings are to be understood as solely schematic illustrations of the fundamental optical design principle, i.e. as not to scale.

### BRIEF DESCRIPTION OF THE DRAWINGS

FIG. 1 shows a vertical longitudinal section through a detail of a vehicle having an integrated privacy display in its preparatory design stage, in which a simple transparent cover pane transmits the projector light uninfluenced.

FIG. 2 shows a vertical longitudinal section through a detail of a vehicle having a privacy display according to an exemplary embodiment of the invention, with a schematic illustration of the beam path of the projector light deflected by its prismatic cover pane.

### DETAILED DESCRIPTION OF THE DRAWINGS

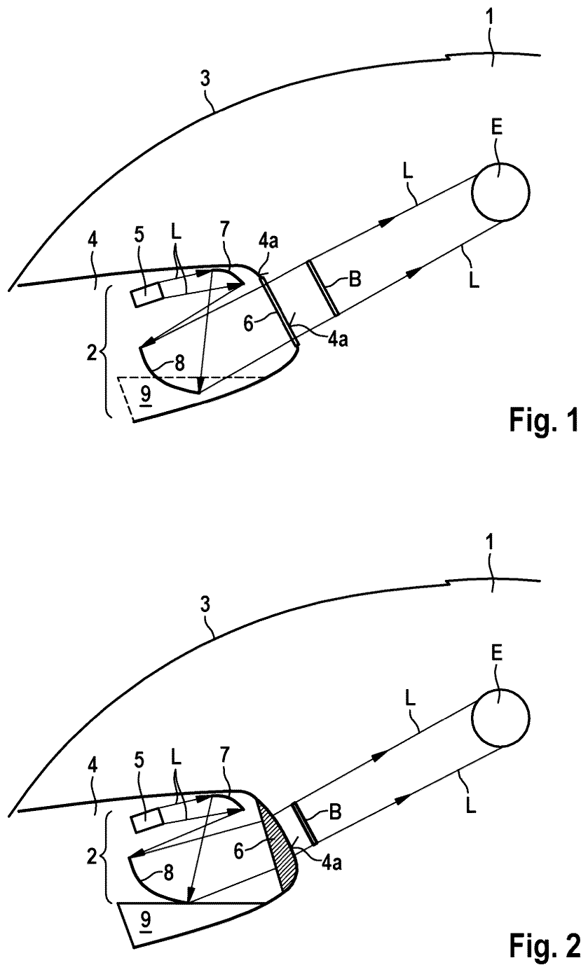

All the various embodiments, alternatives, and specific design features of the privacy display and the vehicle according to the above aspects of the invention which are mentioned above in the description and in the following claims can be implemented in the example shown in FIGS. 1 and 2, in particular also alternatively or additionally to the features shown therein. They are therefore not all repeated once again hereinafter. This also applies accordingly to the above-mentioned term definitions and effects with respect to individual features shown in FIGS. 1 and 2.

FIG. 2 shows a very simplified schematic longitudinal sectional view of an exemplary embodiment of a vehicle 1 having a privacy display 2 of the type presented herein. The vehicle 1 is a motor vehicle in this example, which is indicated in FIG. 2 only by its windshield 3 and an instrument panel 4 extending thereunder. As already mentioned, the spatial orientation terms such as “above”, “below”, “lateral”, “horizontal”, “vertical”, etc. relate to the typical vehicle-fixed Cartesian coordinate system having longitudinal, transverse, and vertical axes of the vehicle 1 perpendicular to one another.

The privacy display 2 is integrated in the interior of the instrument panel 4 and contains an image generator 5 designed to generate a light beam bundle L having desired display content and a cover pane 6 designed to transmit the light beam bundle L. The light beam bundle L (projector light) is indicated in greatly simplified form by its edge beams.

The cover pane 6 is formed in a surface section 4a of the instrument panel 4 which faces toward a vehicle occupant on a front vehicle seat (not shown), so that it is arranged having its surface directly opposite to the occupant. The occupant, in this example a front passenger, is only indicated by spatial area E (eyebox) predetermined for his or her eyes or head. The eyebox E is again solely symbolically outlined and is located in the area of the mentioned vehicle seat.

Furthermore, the privacy display 2 comprises a projection and/or imaging optical unit arranged in the beam path of the projector light L between the image generator 5 and the cover pane 6, which in this example comprises two concave mirrors 7 and 8 located directly opposite to one another. Solely by way of example, these are designed in FIG. 2 for the purpose of imaging the display content generated by the image generator 5 in a real image B floating freely in the air, which can be seen from the eyebox E of the occupant when looking in the direction of the cover pane 6.

An optimal location (in the sense of an image distance) and orientation (in the sense of an image inclination) of the floating image plane between the cover pane 6 and the eyebox E can be achieved here by a suitable selection of the mutual arrangement and design of the image generator 5 and the projection and/or imaging optical unit, which would not be possible using conventional display technologies such as flatscreen displays or head-up displays. In particular, the occupant can observe the real image B here in a floating image plane at a comfortable reading distance between his or her vehicle seat and the instrument panel 4 without his or her arm and leg freedom thus being restricted and without the image inclination depending on the geometry of the surface section 4a of the instrument panel 4. This can accordingly also be achieved alternatively for a virtual image display (not shown) beyond the cover pane 6.

The required emission direction of the light beam bundle L emerging from the cover pane 6 is predetermined here by the vehicle geometry, specifically by the mutual arrangement of the instrument panel 4 and the mentioned vehicle seat having the associated eyebox E. Therefore, an installation space conflict can occur in the design of the projection and/or imaging optical unit if, for example, an installation space area 9 required for this purpose inside the instrument panel 4 is occupied (not shown) by other vehicle units or is not present.

FIG. 1 shows this problem in an auxiliary view which shows the privacy display 2 of FIG. 2 in its preparatory design stage, in which a simple transparent cover pane 6 transmits the light beam bundle L uninfluenced. When such a projector is integrated into the instrument panel 4, an installation space conflict can occur in the mentioned installation space area 9 if it is required for other purposes in the vehicle 1.

As FIG. 2 shows, this installation space conflict can be resolved in that the cover pane 6 is designed as prismatic, in this example as a free-form prism which is only schematically indicated and which follows the external shape of the instrument panel 4 and at the same time also still ensures a deflection of the light beam bundle L upward. In this way, the installation space required for the privacy display 2 can be vertically compressed so that the installation space area 9 required for other purposes is released. As described in more detail above, the free-form prism can additionally contribute here to an optics improvement by way of a corresponding design of its free-form surfaces and/or to a contrast improvement by way of a particle admixture, coloration, or tinting, or by an integrated polarization filter.

### LIST OF REFERENCE SIGNS

1 vehicle
2 privacy display
3 windshield
4 instrument panel
4a surface section of the instrument panel facing toward a vehicle occupant on a front vehicle seat
5 image generator
6 cover pane
7, 8 concave mirrors facing toward one another
9 otherwise occupied installation space area
L light beam bundle, also called projector light
B real image floating in the air
E eyebox

1.-10. (canceled)

11. A compact privacy display for an instrument panel of a vehicle, the privacy display comprising:
an image generator configured to generate a light beam bundle having desired display content:
a cover pane configured to transmit the light beam bundle and to be arranged in a surface section of the instrument panel which faces toward a vehicle occupant on a front vehicle seat; and
a projection and/or imaging optical unit arranged in a beam path between the image generator and the cover pane, which projection and/or imaging optical unit is configured to display the display content as a real or virtual image floating freely in air in front of or behind the cover pane;
wherein the cover pane, for deflecting the light beam bundle upward, is configured as prismatic in order to vertically compress an installation space required for the privacy display and to output the light beam bundle directly in a direction of a spatial area predetermined for eyes of the vehicle occupant.

12. The privacy display according to claim 11, wherein
the cover pane is configured as a free-form prism having a free-form surface facing toward the vehicle occupant and/or the projection and/or imaging optical unit, which free-form surface is configured for adaptation to a predetermined surface geometry of the instrument panel and/or for an additional image-correcting and/or imaging effect.

13. The privacy display according to claim 11, wherein
the cover pane has an at least approximately triangular shape, tapering downward, in a vertical longitudinal section.

14. The privacy display according to claim 11, wherein
the cover pane has an at least approximately triangular shape in a vertical longitudinal section.

15. The privacy display according to claim 11, wherein
the cover pane is darkened by a particle admixture, coloration, or tinting, or by a polarization filter to such an extent that a direct view into an interior of the privacy display is thus essentially prevented for vehicle occupants and a contrast medium for displaying the real or virtual image with a sufficient contrast results.

16. The privacy display according to claim 15, wherein
the polarization filter is configured as a circular polarizer, which is composed of a quarter-wave retarder facing toward the projection and/or imaging optical unit and a linear polarizer facing toward the vehicle occupant.

17. The privacy display according to claim 16, wherein
the image generator is configured to output the light beam bundle with a circular polarization such that after passage through the quarter-wave retarder, the light beam bundle has a linear polarization transmitted by the linear polarizer.

18. The privacy display according to claim 11, wherein
the projection and/or imaging optical unit comprises at least one concave mirror.

19. The privacy display according to claim 18, wherein
the projection and/or imaging optical unit comprises two concave mirrors directly opposite to one another in a beam path of the light beam bundle.

20. A motor vehicle having longitudinal, transverse, and vertical axes of a vehicle-fixed Cartesian coordinate system perpendicular to one another, the motor vehicle comprising:
a windshield, the instrument panel extending under the windshield, and the front vehicle seat arranged opposite to the instrument panel; and
at least one privacy display according to claim 11, which at least one privacy display is integrated into the instrument panel so that the cover pane forms the surface section of the instrument panel, which faces toward the vehicle occupant on the front vehicle seat.

21. The vehicle according to claim 20, wherein
the cover pane is arranged in the instrument panel so that a user-side surface of the cover pane is flush with adjoining surface sections of the instrument panel.

22. The vehicle according to claim 20, wherein
a first one of the at least one privacy display is arranged opposite to a front passenger seat and is configured for front passenger entertainment; and/or
a second one of the at least one privacy display is arranged opposite to a driver seat and is configured for driver entertainment during autonomous driving or in a parked state of the vehicle.
